(19) United States
(12) Patent Application Publication
(10) Pub. No.: US 2012/0016674 A1
(43) Pub. Date: Jan. 19, 2012

(54) Modification of Speech Quality in Conversations Over Voice Channels

(75) Inventors: Sarah H. Basson, White Plains, NY (US); Dimitri Kanevsky, Ossining, NY (US); David Nahamoo, Great Neck, NY (US); Tara N. Sainath, New York, NY (US)

(73) Assignee: International Business Machines Corporation, Armonk, NY (US)

(21) Appl. No.: 12/838,103

(22) Filed: Jul. 16, 2010

(51) Int. Cl. G10L 13/00

(52) U.S. Cl. 704/258; 704/E13.001

(57) ABSTRACT

Techniques are disclosed for modifying speech quality in a conversation over a voice channel. For example, a method for modifying a speech quality associated with a spoken utterance transmittable over a voice channel comprises the following steps. The spoken utterance is obtained prior to an intended recipient of the spoken utterance receiving the spoken utterance. An existing speech quality of the spoken utterance is determined. The existing speech quality of the spoken utterance is compared to at least one desired speech quality associated with at least one previously obtained spoken utterance to determine whether the existing speech quality substantially matches the desired speech quality. At least one characteristic of the spoken utterance is modified to change the existing speech quality of the spoken utterance to the desired speech quality when the existing speech quality does not substantially match the desired speech quality. The spoken utterance is presented with the desired speech quality to the intended recipient.

### FIELD OF THE INVENTION

The present invention relates generally to speech signal processing and, more particularly, to modifying speech quality in a conversation over a voice channel.

### BACKGROUND OF THE INVENTION

In a climate of expensive travel and increased cost-cutting, more business is transacted over the telephone and other remote methods rather than face-to-face meetings. It is therefore desirable to put the “best foot forward” in these remote communications, since this has become a common mode of doing business and individuals need to create impressions given access only to voice channels.

On any given day, however, or at any particular point during the day, a conversant's voice might not be in “best form.” A speaker might want to make a convincing sales pitch or compelling presentation, but can not naturally muster the level of enthusiasm that he/she would want in order to sound authoritative, energetic, etc.

Some users might be unable to attain the prosodic range that is needed in a particular setting, due to disabilities such as aphasia, autism, or deafness.

Alternatives include corresponding through text, and using textual cues to indicate emotion, energy, etc. But text is not always the ideal channel to use to conduct business.

Another option involves face-to-face meetings, where other characteristics (affect, gestures, etc.) can be leveraged to make strong points. As mentioned earlier though, face-to-face meetings are not always logistically possible.

### SUMMARY OF THE INVENTION

Principles of the invention provide techniques for modifying speech quality in a conversation over a voice channel. The inventive techniques also permit a speaker to selectively manage such modifications.

For example, in accordance with one aspect of the invention, a method for modifying a speech quality associated with a spoken utterance transmittable over a voice channel comprises the following steps. The spoken utterance is obtained prior to an intended recipient of the spoken utterance receiving the spoken utterance. An existing speech quality of the spoken utterance is determined. The existing speech quality of the spoken utterance is compared to at least one desired speech quality associated with at least one previously obtained spoken utterance to determine whether the existing speech quality substantially matches the desired speech quality. At least one characteristic of the spoken utterance is modified to change the existing speech quality of the spoken utterance to the desired speech quality when the existing speech quality does not substantially match the desired speech quality. The spoken utterance is presented with the desired speech quality to the intended recipient.

A speech quality of the spoken utterance may comprise a perceivable mood or an emotion of the spoken utterance (e.g., happy, sad, confident, enthusiastic, etc.). A speech quality of the spoken utterance may comprise a perceivable intention of the spoken utterance (e.g., question, command, sarcasm, irony, etc.).

The desired speech quality may be manually selected based on a preference of the speaker of the spoken utterance (e.g., selectable via a user interface).

The desired speech quality may be automatically selected based on a substantive context associated with the spoken utterance and a determination as to how the spoken utterance should sound to the intended recipient. In one embodiment, the desired speech quality may be automatically selected by analyzing the content of the spoken utterance and determining a voice match for how the spoken utterance should sound to achieve an objective. A voice match may be determined based on one or more voice models previously created for the speaker of the spoken utterance. At least one of the one or more voice models may be created via background data collection (e.g., substantially transparent to the speaker) or via explicit data collection (e.g., with speaker's express knowledge and/or participation).

The method may also comprise the speaker marking (e.g., via a user interface) one or more spoken utterances. The marked spoken utterances may be analyzed to determine subsequent desired speech qualities.

The method may also comprise editing the content of the spoken utterance when it is determined to contain undesirable language.

The at least one characteristic of the spoken utterance that is modified in the modifying step may comprise a prosody associated with the spoken utterance. In one embodiment, the at least one characteristic of the spoken utterance may be modified prior to transmission of the spoken utterance (e.g., at speaker end of voice channel). In another embodiment, the at least one characteristic of the spoken utterance may be modified after transmission of the spoken utterance (e.g., at the intended recipient end of the voice channel).

Other aspects of the invention comprise apparatus and articles of manufacture for implementing and/or realizing the above-described method steps.

These and other features, objects and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram of a system for creating a voice model for a particular speaker in accordance with an embodiment of the invention.

FIG. 2 is a diagram of a system for substituting appropriate spoken language for inappropriate spoken language in accordance with an embodiment of the invention.

FIG. 3 is a diagram of a user interface for selecting desired prosodic characteristics in accordance with an embodiment of the invention.

FIG. 4 is a diagram of a methodology for processing a speech signal in accordance with an embodiment of the invention.

FIG. 5 is a diagram of a computing system for implementing one or more steps and/or components in accordance with one or more embodiments of the invention.

### DETAILED DESCRIPTION OF THE INVENTION

Principles of the present invention will be described herein in the context of telephone conversations. It is to be appreciated, however, that the principles of the present invention are not limited to use in telephone conversations but rather may be applied in accordance with any suitable voice channels where it is desirable to modify the quality of speech. For this reason, numerous modifications can be made to the embodiments shown that are within the scope of the present invention. That is, no limitations with respect to the specific embodiments described herein are intended or should be inferred.

As used herein, the term “prosody” is a characteristic of a spoken utterance and may refer to one or more of the rhythm, stress, and intonation of speech. Prosody may reflect various features of the speaker or the utterance including, but not limited to: the emotional state of a speaker; whether an utterance is a statement, a question, or a command; whether the speaker is being ironic or sarcastic; emphasis, contrast, and focus; or other elements of language that may not be encoded by grammar or choice of vocabulary. In terms of acoustics, the “prosodies” of oral languages involve variation in syllable length, loudness, pitch, and the formant frequencies of speech sounds.

The phrase “speech quality,” as used herein, is intended to generally refer to a perceivable mood or emotion of the speech, e.g., happy speech, sad speech, enthusiastic speech, bland speech, etc., rather than quality of speech in the sense of transmission errors, noise, distortion and losses due to low bit-rate coding and packet transmission, etc. Also, “speech quality” as used herein may refer to a perceivable intention of the speech, e.g., command, question, sarcasm, irony, etc., that is conveyed by means other than what is conveyed by choice of grammar and vocabulary.

It is to be understood that when it is stated herein that a spoken utterance is obtained, compared, modified, presented, or manipulated in some other manner, it is generally understood to mean that one or more electrical signals representative of the spoken utterance are obtained, compared, modified, presented, or manipulated in some other manner using speech signal input, processing, and output techniques.

Illustrative embodiments of the invention overcome the drawbacks mentioned above in the background section, as well as other drawbacks, by providing for use of voice morphing (altering) techniques to emphasize key points in a speech sample and to selectively convert a speaker's voice to exhibit one quality rather than another quality, by way of example only, convert bland speech to enthusiastic speech.

This enables users to more effectively conduct business using the voice channel of the telephone, even when their voice of their mood (as manifested in their voice) is not in best form.

Furthermore, illustrative embodiments of the invention allow a user to indicate how he/she wants his/her voice to sound during a conversation. The system can also automatically determine how the user should appropriately sound, given the context of the material spoken. This can be accomplished by analyzing the content of what the speaker is saying and then creating a “voice match” for how the speaker should sound to make points more appropriately.

Still further, illustrative embodiments of the invention can also automatically analyze prior “successful” or “unsuccessful” conversations, as marked by the speaker. The prosody and voice quality of the “successful” conversations can then be mapped to future conversations on similar topics.

Also, illustrative embodiments of the invention can create different voice models that reflect emotional states, for example, “happy voice,” serious voice,” etc.

Users can indicate a priori how they want their voice to “sound” in a particular conversation (e.g., enthusiastic, disappointed, etc.).

Illustrative embodiments of the invention can also automatically determine how the user should appropriately sound, given the context of the material spoken. This can be accomplished by analyzing the content of what the speaker is saying (using speech recognition and text analytics) and then creating a “voice match” for how the speaker should sound to make points more appropriately.

To establish the baseline of “target voices,” a user creates models of his/her voice in the desired modes, for example, “cheerful,” “serious,” etc. The user thereby has a customized set of voice models, where the only dimension that is being modified is “perceived emotion.”

Another option in creating voice models that reflect different emotional states can be done as a “background” data collection, rather than an “explicit” data collection. Users can be speaking as a function of their normal activities, and “mark” whether they are feeling “happy” or “sad” during a given segment. The segments of speech produced while the user perceives him/herself as “happy,” “sad,” etc. could be used to populate an “emotional speech” database.

Another method entails automatically identifying “happy voice,” “serious voice”, etc. The system automatically monitors and records the user over an extended period of time. Segments of “happy speech,” “serious speech,” etc. are detected automatically using acoustic features correlating with different moods.

Using phrase splicing technology, strings of utterances can be created that reflect “cheerful voice” versions of what the user is saying, or more “serious” versions.

The utterances that a user is saying can be automatically recognized using speech recognition, and then re-synthesized to project the mood/prosody that the user opts to project.

In cases where the user cannot create the database and repertoire of “happy speech samples” or “serious speech samples,” the system can use rule-generated methods to re-synthesize the user's speech to reflect “happy” or “sad.” For example, increased fundamental frequency shifts can be imposed to create more “animated” speech.

In addition to modifying the prosody, this technique can also edit the content of what the user is saying. If the user has used inappropriate language, for example the sentence can be re-synthesized such that the objectionable phrase is eliminated, or replaced with a more acceptable synonym.

Once the models have been created that represent the user's voice in a number of modes, the user can select from a range of options to determine which voice he/she opts to project in a particular conversation, or which voice he/she opts to project at a particular portion of the conversation. This can be instantiated using “buttons” on a user interface such as “happy voice,” “serious voice,” etc. Samples of speech strings in each of the available moods can be played for the user prior to selection.

Illustrative embodiments of the invention can be deployed to assist speakers with impaired prosodic variety. These populations can include: individuals with inherently monotonous voices, individuals with various types of aphasias, deaf individuals, or people with autism. In some cases, they might be unable to modify their prosody, even though they know what target they are trying to achieve. In other cases, the individuals might not be aware of the correlation between “happy speech” and associated voice quality, e.g., autistic speakers. The ability to select a “button” that marks “happy speech” and thereby automatically introduces different prosodic variations may be desirable.

Note that for the latter group, the individuals themselves may not be able to “train” the system for “this is how I sound when I am happy/sad/etc.” In these cases, rule-governed modifications that change their speech prosody are introduced and their speech is thereby re-synthesized.

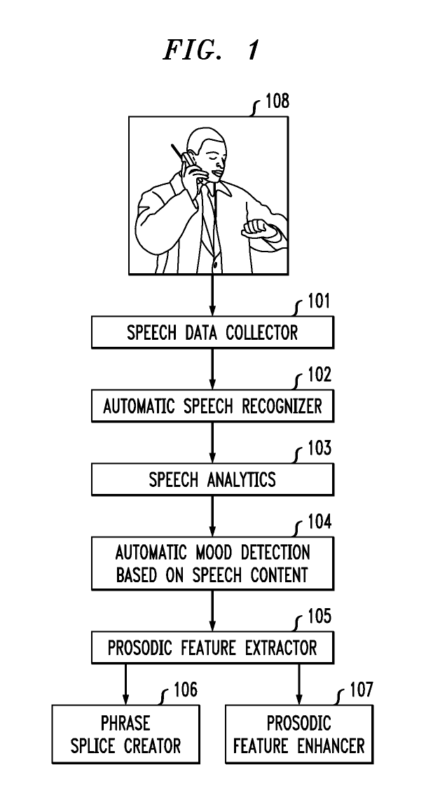

FIG. 1 shows a system for creating a voice model for a particular speaker according to an embodiment of the invention. As shown, speaker 108 communicates over the telephone. It is to be appreciated that the telephone system might be wireless or wired. Principles of the invention are not intended to be restricted to the type of voice channel or communication system that is employed to receive/transmit speech signals.

His/her speech is collected through a speech data collector 101 and passed through an automatic speech recognizer 102, where it is transcribed to text. The speech data collector 101 may be a storage repository for the speech being processed by the system. Automatic speech recognizer 102 may utilize any conventional automatic speech recognition (ASR) techniques to transcribe the speech to text.

A speech analyzer 103 applies speech analytics to the text output by the automatic speech recognizer 102. Examples of speech analytics may include, but are not limited to, determination of topics being discussed, identities of speakers, genders of the speakers, emotion of speakers, amount and location of speech versus background non-speech noise, etc.

An automatic mood detector 104 is activated to determine whether the speaker's voice is transmitting as “happy,” “sad,” “bored,” etc. That is, the automatic mood detector 104 determines the “speech quality” of the speech uttered by the user 108. The mood could be detected by examining a variety of features in the speech signal including, but not limited to, energy, pitch, and prosody. Examples of emotion/mood detection techniques that can be applied in detector 104 are described in U.S. Pat. No. 7,373,301, U.S. Pat. No. 7,451,079, and U.S. Patent Publication No. 2008/0040110, the disclosures of which are incorporated by reference herein in their entireties.

Prosodic features associated with the speaker's mood are extracted via a prosodic feature extractor 105. If there is no suitable “mood phrase” in the speaker's repertoire, then new phrases are created that reflect the desired target mood, via a phrase splice creator 106. If there are suitable phrases that reflect the desired mood in the speaker's repertoire, then those “mood enhancements” are superimposed on the existing phrase using a prosodic feature enhancer 107. Examples of techniques for prosodic feature extraction, phrase splicing, and feature enhancement that can be applied in modules 105, 106 and 107 are described in U.S. Pat. No. 6,961,704, U.S. Pat. No. 6,873,953, and U.S. Pat. No. 7,069,216, the disclosures of which are incorporated by reference herein in their entireties.

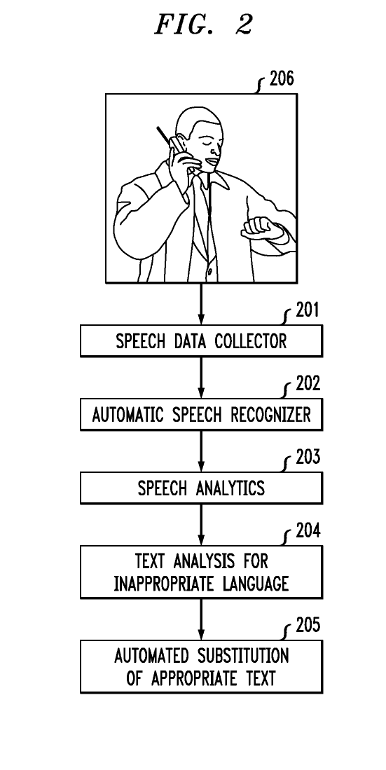

FIG. 2 shows a system for substituting appropriate spoken language for inappropriate spoken language according to an embodiment of the invention. As shown, speaker 206 communicates over the telephone. Again, principles of the invention are not limited to any particular type of telephone system. His/her speech is collected through a speech data collector 201 (same as or similar to 101 in FIG. 1) and passed through an automatic speech recognizer 202 (same as or similar to 102 in FIG. 1), where it is transcribed to text. A speech analyzer 203 (same as or similar to 103 in FIG. 1) applies speech analytics to the text output.

The text is then analyzed by a text analyzer 204 to determine whether inappropriate language was used (e.g., profanities, insults, etc.). In the event that inappropriate language is identified, appropriate text is introduced to replace it via an automated text substitution module 205. The modified text is then re-synthesized in the speaker's voice in module 205 via conventional text-to-speech techniques. Examples of techniques for text analysis and substitution with regard to inappropriate language that can be applied in modules 204 and 205 are described in U.S. Pat. No. 7,139,031, U.S. Pat. No. 6,807,563, U.S. Pat. No. 6,972,802, and U.S. Pat. No. 5,521,816, the disclosures of which are incorporated by reference herein in their entireties.

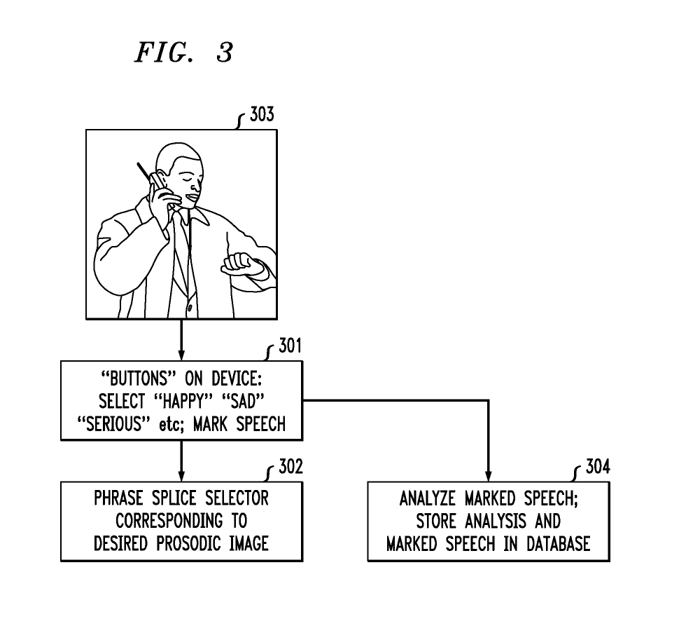

FIG. 3 shows a user interface for selecting desired prosodic characteristics according to an embodiment of the invention. Speaker 303 on the telephone is having a conversation, and knows that he wants to sound “happy” or “serious” on this particular call. He activates one or more buttons (keys) on his telephone device (user interface) 301 that will automatically morph his voice into his desired target prosody. A phrase splice selector 302 extracts the appropriate prosodic phrase splices, and supplants the current phrases that the user wants modified.

The methodology of FIG. 3 operates in two steps. First, a phrase segmenter detects appropriate phrases to segment. Examples of phrase segmenters that may be employed here are described in U.S. Patent Publication No. 2009/0259471, U.S. Pat. No. 5,797,123, and U.S. Pat. No. 5,806,021, the disclosures of which are incorporated by reference herein in their entireties. Second, once the phrases are segmented, the emotion within each of the segments is changed based on the suggested emotion desired by the user. Examples of emotion alteration that may be employed here are described in U.S. Pat. No. 5,559,927, U.S. Pat. No. 5,860,064 and U.S. Pat. No. 7,379,871, the disclosures of which are incorporated by reference herein in their entireties.

Illustrative embodiments of the invention also permit the user to mark (annotate) segments of speech produced which the user himself perceived as happy, sad, etc. This is illustrated in FIG. 3, where the user 303 may again use one or more buttons (keys) on his telephone (user interface) 301 to denote the start time and stop time between which his spoken utterances are to be selected for analysis. This allows for many benefits. First, for example, collecting feedback from the user allows for the creation of an emotional database 304. Second, for example, error analysis 304 can be performed to determine places where the system created a different emotion than the user hypothesized, to improve the emotion creation of the speech in the future. Examples of speech annotation techniques that may be employed here are described in U.S. Pat. No. 7,506,262, and U.S. Patent Publication No. 2005/0273700, the disclosures of which are incorporated by reference herein in their entireties.

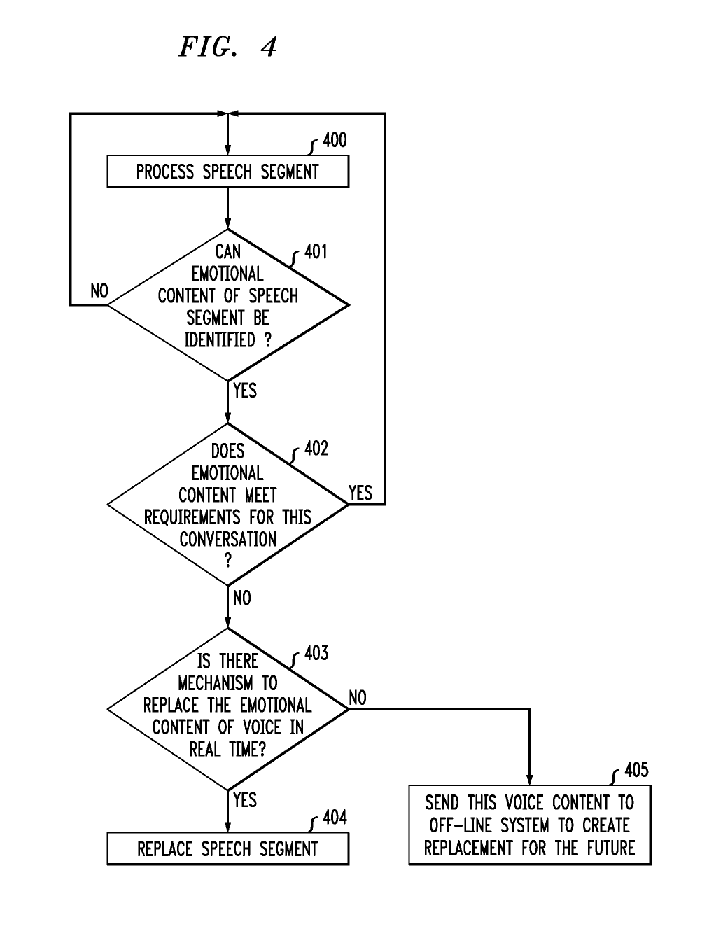

FIG. 4 shows a methodology for processing a speech signal according to an embodiment of the invention. Speech segments produced by the person on the telephone are spliced, and processed, in step 400. Determination is made as to whether the “emotional content” of the speech segment can be classified, in step 401. If it can, a determination is made as to whether the emotional content of the phrase matches what is needed in this context, and/or whether it matches what the user indicated as his desired prosodic messaging for this call, in step 402.

If the emotional content cannot be classified in step 401, then the system continues processing the next speech segment.

If the emotional content fits the needs of this particular conversation, as determined in step 402, then the system processes the next speech segment in step 400. If the emotional content, as determined in step 402, does not match the desired requirements for this conversation, then the system checks whether there is a mechanism to replace this speech segment in real time with a prosodically appropriate segment, in step 403. If there is a mechanism and appropriate speech segment to replace it with, then the replacement takes place in step 404. If there is no immediately available speech segment that can replace the original speech segment, then the speech is sent to an off-line system to generate the replacement for future playback of this message with appropriate prosodic content, in step 405.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1-4, the diagrams in the figures illustrate the architecture, functionality, and operation of possible implementations of systems, methods and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-4, can also include, as described herein, providing a system, wherein the system includes distinct modules (e.g., modules comprising software, hardware or software and hardware). By way of example only, the modules may include, but are not limited to, a speech data collector module, an automatic speech recognizer module, a speech analytics module, an automatic mood detection module, a text analysis module, an automated speech substitution module, a prosodic feature extractor module, a phrase splice creator module, a prosodic feature enhancer module, a user interface module, and a phrase splice selector module. These and other modules may be configured, for example, to perform the steps described and illustrated in the context of FIGS. 1-4.

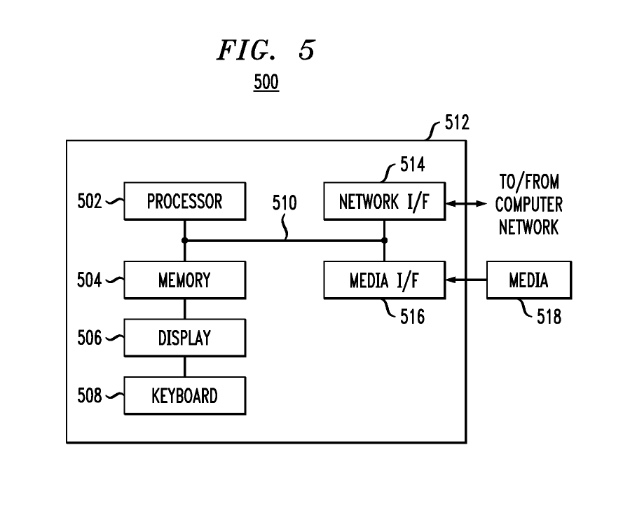

One or more embodiments can make use of software running on a general purpose computer or workstation. With reference to FIG. 5, such an implementation 500 employs, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer).

The processor 502, memory 504, and input/output interface such as display 506 and keyboard 808 can be interconnected, for example, via bus 510 as part of a data processing unit 512. Suitable interconnections, for example, via bus 510, can also be provided to a network interface 514, such as a network card, which can be provided to interface with a computer network, and to a media interface 516, such as a diskette or CD-ROM drive, which can be provided to interface with media 518.

A data processing system suitable for storing and/or executing program code can include at least one processor 502 coupled directly or indirectly to memory elements 504 through a system bus 510. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 508, display 506, pointing device, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modem and Ethernet cards are just a few of the currently available types of network adapters.

As used herein, a “server” includes a physical data processing system (for example, system 512 as shown in FIG. 5) running a server program. It will be understood that such a physical server may or may not include a display and keyboard.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for modifying a speech quality associated with a spoken utterance transmittable over a voice channel, comprising steps of:
obtaining the spoken utterance prior to an intended recipient of the spoken utterance receiving the spoken utterance;
determining an existing speech quality of the spoken utterance;
comparing the existing speech quality of the spoken utterance to at least one desired speech quality associated with at least one previously obtained spoken utterance to determine whether the existing speech quality substantially matches the desired speech quality;
modifying at least one characteristic of the spoken utterance to change the existing speech quality of the spoken utterance to the desired speech quality when the existing speech quality does not substantially match the desired speech quality; and
presenting the spoken utterance with the desired speech quality to the intended recipient.

2. The method of claim 1, wherein a speech quality of the spoken utterance comprises a perceivable mood or an emotion of the spoken utterance.

3. The method of claim 1, wherein a speech quality of the spoken utterance comprises a perceivable intention of the spoken utterance.

4. The method of claim 1, wherein the desired speech quality is manually selected based on a preference of the speaker of the spoken utterance.

5. The method of claim 1, wherein the desired speech quality is automatically selected based on a substantive context associated with the spoken utterance and a determination as to how the spoken utterance should sound to the intended recipient.

6. The method of claim 5, wherein the desired speech quality is automatically selected by analyzing the content of the spoken utterance and determining a voice match for how the spoken utterance should sound to achieve an objective.

7. The method of claim 6, wherein a voice match is determined based on one or more voice models previously created for the speaker of the spoken utterance.

8. The method of claim 7, wherein at least one of the one or more voice models are created via background data collection.

9. The method of claim 7, wherein at least one of the one or more voice models are created via explicit data collection.

10. The method of claim 1, wherein the at least one characteristic of the spoken utterance that is modified in the modifying step comprises a prosody associated with the spoken utterance.

11. The method of claim 1, further comprising the step of the speaker marking one or more spoken utterances.

12. The method of claim 11, wherein the marked spoken utterances are analyzed to determine subsequent desired speech qualities.

13. The method of claim 1, further comprising the step of editing the content of the spoken utterance when it is determined to contain undesirable language.

14. The method of claim 1, wherein the at least one characteristic of the spoken utterance is modified prior to transmission of the spoken utterance.

15. The method of claim 1, wherein the at least one characteristic of the spoken utterance is modified after transmission of the spoken utterance.

16. Apparatus for modifying a speech quality associated with a spoken utterance transmittable over a voice channel, comprising:
a memory; and
at least one processor device operatively coupled to the memory and configured to:
obtain the spoken utterance prior to an intended recipient of the spoken utterance receiving the spoken utterance;
determine an existing speech quality of the spoken utterance;
compare the existing speech quality of the spoken utterance to at least one desired speech quality associated with at least one previously obtained spoken utterance to determine whether the existing speech quality substantially matches the desired speech quality;
modify at least one characteristic of the spoken utterance to change the existing speech quality of the spoken utterance to the desired speech quality when the existing speech quality does not substantially match the desired speech quality; and
present the spoken utterance with the desired speech quality to the intended recipient.

17. The apparatus of claim 16, wherein a speech quality of the spoken utterance comprises a perceivable mood or an emotion of the spoken utterance.

18. The apparatus of claim 16, wherein a speech quality of the spoken utterance comprises a perceivable intention of the spoken utterance.

19. The apparatus of claim 16, wherein the desired speech quality is manually selected based on a preference of the speaker of the spoken utterance.

20. The apparatus of claim 16, wherein the desired speech quality is automatically selected based on a substantive context associated with the spoken utterance and a determination as to how the spoken utterance should sound to the intended recipient.

21. The apparatus of claim 16, wherein the at least one characteristic of the spoken utterance that is modified in the modifying step comprises a prosody associated with the spoken utterance.

22. The apparatus of claim 16, wherein the at least one processor device is further configured to permit the speaker to mark one or more spoken utterances.

23. The apparatus of claim 22, wherein the marked spoken utterances are analyzed to determine subsequent desired speech qualities.

24. The apparatus of claim 16, wherein the at least one processor device is further configured to edit the content of the spoken utterance when it is determined to contain undesirable language.

25. An article of manufacture for modifying a speech quality associated with a spoken utterance transmittable over a voice channel, the article of manufacture comprising a computer readable storage medium having tangibly embodied thereon computer readable program code which, when executed, causes a computer to:
obtain the spoken utterance prior to an intended recipient of the spoken utterance receiving the spoken utterance;
determine an existing speech quality of the spoken utterance;
compare the existing speech quality of the spoken utterance to at least one desired speech quality associated with at least one previously obtained spoken utterance to determine whether the existing speech quality substantially matches the desired speech quality;
modify at least one characteristic of the spoken utterance to change the existing speech quality of the spoken utterance to the desired speech quality when the existing speech quality does not substantially match the desired speech quality; and
present the spoken utterance with the desired speech quality to the intended recipient.
